(19) United States
(12) Patent Application Publication
(10) Pub. No.: US 2012/0328895 A1
(43) Pub. Date: Dec. 27, 2012

(54) PRE-TREATMENT FOR PRESERVATION OF WOOD

(75) Inventor: Hideki Yamaguchi, Kyoto (JP)

(73) Assignee: EMPIRE TECHNOLOGY DEVELOPMENT LLC, Wilmington, DE (US)

(21) Appl. No.: 13/513,140

(22) PCT Filed: Jun. 9, 2011
(86) PCT No.: PCT/US11/39745

§ 371 Date: May 31, 2012

(51) Int. Cl. B27K 3/12; F26B 5/00; B27K 3/00

(52) U.S. Cl. 428/541; 427/325; 34/357

(57) ABSTRACT

The present application relates to methods of pre-treating wood, methods of drying wood, and methods of preserving wood. The methods include providing untreated wood, and applying an ionic liquid to the untreated wood. The methods also can include drying the wood after applying the ionic liquid to the wood. The methods also can include applying a preservative to the wood. Also provided herein are wood products produced by the methods provided herein.

### BACKGROUND

1. Field

The present application relates to wood preservation, for example, pre-treatment technology and drying technology for improving wood preservation.

2. Description of the Related Art

In preservative treatment of wood, heavy-metal-based wood preservatives are used. For example, heavy-metal-based wood preservatives such as CCA (chromium, copper, arsenic) are used, but such preservatives have problems with safety and create environmental challenges.

Furthermore, traditional wood preservative treatments, despite utilizing preservatives with substantial activity, fall short of providing the levels of preservation expected from using such preservatives.

### SUMMARY

Some embodiments disclosed herein include a method of preserving wood, the method comprising: (a) providing untreated wood; (b) applying an ionic liquid to the untreated wood to produce pre-treated wood, wherein the permeability of the pre-treated wood is higher than the permeability of the untreated wood; and (c) applying a preservative to the pre-treated wood. In some embodiments, the ionic liquid comprises as least one cation and at least one anion; and wherein the cation is selected from the group consisting of:

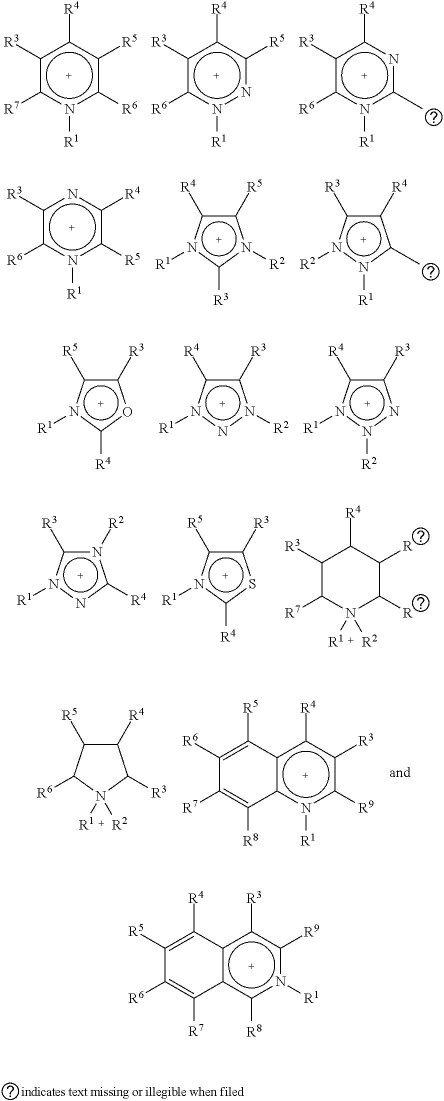

wherein R¹ is C₁-C₆ alkyl or C₁-C₆ alkoxyalkyl; wherein R² is C₁-C₆ alkyl or C₁-C₆ alkoxyalkyl; and wherein R³, R⁴, R⁵, R⁶, R⁷, R⁸, and R⁹, when present, are each independently hydrogen, hydroxy, C₁-C₆ alkyl, C₁-C₆ alkoxyalkyl, or C₁-C₆ alkoxy, and wherein the anion of the ionic liquid is selected from the group consisting of halide, pseudohalide, phosphate and C₁-C₆ carboxylate. In some embodiments, the ionic liquid contains at least one dialkylimidazolium cation. In some embodiments, the ionic liquid contains at least one methylbutylimidazolium cation. In some embodiments, the ionic liquid contains at least one anion selected from the group consisting of chloride, acetate, and phosphate. In some embodiments, the ionic liquid is selected from the group consisting of dialkylimidazolium chloride, dialkylimidazolium, dialkylimidazolium acetate, dialkylimidazolium phosphate, methylbutylimidazolium chloride, methylbutylimidazolium acetate, and methylbutylimidazolium phosphate. In some embodiments, the ionic liquid is admixed with water prior to applying the ionic liquid to the wood. In some embodiments, the ratio of ionic liquid:water is about 1:99 to about 1:9 (w/w). In some embodiments, the quantity of ionic liquid applied to the wood is about 0.01 mg/cm² to about 1 mg/cm². In some embodiments, the ionic liquid is sprayed onto the wood. In some embodiments, the ionic liquid is applied to the wood at a pressure of about 0.1 kg/cm² to about 2 kg/cm². In some embodiments, the preservative is applied to the pre-treated wood within about 5 hours after applying the ionic liquid to the wood. In some embodiments, the preservative is applied to the pre-treated wood no more than about 24 hours after applying the ionic liquid to the wood. In some embodiments, the ionic liquid and preservative are simultaneously applied to the wood.

Some embodiments provide a preserved wood product that has been preserved according to a method provided herein.

Some embodiments herein provide a method of improving drying of wood, the method comprising: (a) providing untreated wood; and (b) applying an ionic liquid to the untreated wood to produce treated wood, where the permeability of the treated wood is higher than the permeability of the untreated wood, and the ionic liquid applied to the untreated wood accelerates drying of the treated wood relative to untreated wood, but does not preserve the treated wood. In some embodiments, the quantity of ionic liquid applied to the wood is about 0.01 mg/cm² to about 1 mg/cm². In some embodiments, the ionic liquid is admixed with water prior to contacting wood with the ionic liquid. In some embodiments, the ratio of ionic liquid:water is about 1:99 to about 1:9 (w/w). Some embodiments further comprise drying the treated wood.

Some embodiments provide a dried wood product that has been dried according to a method provided herein.

Some embodiments provide a method of preserving wood comprising applying a preservative to wood, wherein the wood has been treated by a method of improving wood drying provided herein.

Some embodiments provide method of preserving wood comprising applying a preservative to wood, wherein, prior to applying the preservative to the wood, the wood contains an ionic liquid.

In some embodiments, the preservative is not an ionic liquid. In some embodiments, the preservative is applied to the treated wood within about 5 hours after applying the ionic liquid to the wood. In some embodiments, the preservative is applied to the treated wood no more than about 24 hours after applying the ionic liquid to the wood. In some embodiments, the ionic liquid and preservative are simultaneously applied to the wood.

Some embodiments provide a preserved wood product that has been preserved according to a method provided herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail, in part through use of the accompanying drawings.

FIG. 1 shows photos of cellulose fibrils affected by the ionic liquid (400× magnification). In particular, cellulose fibrils were placed into a liquid solution of 1-butyl-3-methylimidazolium chloride/dimethylacetamide (80/20 wt/wt) at room temperature and observed under optical microscope.

FIGS. 2-5 are flow charts illustrating non-limiting embodiments of the methods provided herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Among the embodiments provided herein are methods of using a cellulose-dissolving solvent to improve drying and treatment solution-permeability of wood by dissolving cellulose microfibrils that form pits in the wood. In particular, the cellulose-dissolving solvent contains an ionic liquid. In some embodiments, provided is a method of preserving wood, the method comprising providing untreated wood, applying an ionic liquid to the untreated wood to produce pre-treated wood, wherein the permeability of the pre-treated wood is higher than the permeability of the untreated wood, and applying a preservative to the pre-treated wood. In some embodiments, provided is a method of improving drying of wood, the method comprising providing untreated wood, and applying an ionic liquid to the untreated wood to produce treated wood, where the permeability of the treated wood is higher than the permeability of the untreated wood, and where the ionic liquid is applied to the untreated wood in a quantity sufficient to accelerate drying of the treated wood relative to untreated wood, but insufficient to preserve the treated wood.

### DEFINITIONS

As used herein, and “ionic liquid” is a salt that is in liquid form below 100° C. In some embodiments, the ionic liquid is in liquid form below 50° C., 40° C., 30° C., 25° C., or 20° C.

As used herein, “untreated wood” is a wood product that has not been treated to alter the cellulose structure or composition in the pits of the wood product. For example, untreated wood can include a wood product that has not been treated to dissolve the cellulose microfibrils in the pits of the wood product. Typically, the untreated wood used in the methods provided herein includes hardwoods, softwoods, lumber, or other wood for which the goal is the preservation thereof. Typically, the largest dimension of a piece of untreated wood used in the methods provided herein is at least or at least about 20, 30, 40, 50, 60, 70, 80, 90 or 100 cm.

As used herein, “pre-treated wood” is a wood product that has been treated to alter the cellulose structure or composition in the pits relative to the corresponding untreated wood product. For example, pre-treated wood can include a wood product that has been treated to dissolve the cellulose microfibrils in the pits of the wood product.

As used herein, “alkyl” refers to a straight or branched hydrocarbon chain that comprises a fully saturated (no double or triple bonds) hydrocarbon group. The alkyl group of the compounds may be designated as “C₁-C₆ alkyl” or similar designations. By way of example only, “C₁-C₆ alkyl” indicates that there are one to six carbon atoms in the alkyl chain, e.g., the alkyl chain is selected from methyl, ethyl, propyl, iso-propyl, n-butyl, iso-butyl, sec-butyl, t-butyl, and the assorted variants of 5- and 6-carbon hydrocarbon groups. Typical alkyl groups include, but are in no way limited to, methyl, ethyl, propyl, isopropyl, butyl, isobutyl, tertiary butyl, pentyl, hexyl, and the like. The alkyl group may be substituted or unsubstituted.

As used herein, “alkoxy” refers to the formula —OR where R is an alkyl as defined above. A non-limiting list of alkoxys is methoxy, ethoxy, n-propoxy, 1-methylethoxy (isopropoxy), n-butoxy, iso-butoxy, sec-butoxy, tert-butoxy, and the like. An alkoxy may be substituted or unsubstituted.

The term “carboxy” used herein refers to —COOH or the term “carboxylate” used herein refers to the anion of —COOH or a carboxylic acid.

The term “alkoxyalkyl” used herein refers to an alkoxy groups appended to an alkyl radical as defined above. The alkoxyalkyl group of the compounds may be designated as “C₁-C₆ alkoxyalkyl” or similar designations. By way of example only, “C₁-C₆ alkoxyalkyl” indicates that there are one to six carbon atoms in the alkoxyalkyl moiety. Examples of alkoxyalkyl groups include, but are not limited to, methoxymethyl, ethoxyethyl, methoxypropyl, ethoxybutyl, and the like.

The term “halo” used herein refers to fluoro, chloro, bromo, or iodo or the term “halide” used herein refers to fluoride, chloride, bromide, or iodide.

As used herein, “pseudohalide” refers to a monovalent anion having properties similar to those of halides, as described in, for example, Schriver et al., Inorganic Chemistry, W. H. Freeman & Co., New York (1990) 406-407. Pseudohalides include the cyanide (CN⁻¹), thiocyanate (SCN⁻¹), cyanate (OCN⁻¹), fulminate (CNO⁻¹), azide (N₃⁻¹), and C₁-C₆ carboxylate anions. Carboxylate anions that contain 1-6 carbon atoms (C₁-C₆ carboxylate) and are illustrated by formate, acetate, propionate, butyrate, hexanoate, maleate, fumarate, oxalate, lactate, and pyruvate.

As used herein, “substituted” refers to independent replacement of one, two, three, or more of the hydrogen atoms in the specified structure with one of the following substituents: halogen, C₁₋₆ alkyl, C₁₋₆ haloalkyl, C₁₋₆ hydroxyalkyl, C₁₋₆ alkoxy, ester, and C₁₋₆ alkyl-N(R^{A})(R^{B}), where R^{A} and R^{B} are each independently selected from hydrogen and C₁₋₆ alkyl.

### Methods of Pre-Treating Wood

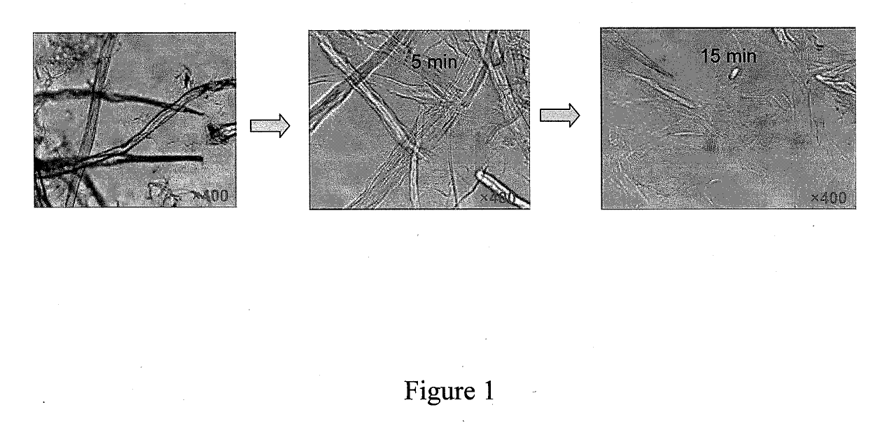

Drying of wood is achieved by opening the pits to evaporate water. This has the added effect of providing a path for infiltrating a treatment solution such as a preservative injected therein. By dissolving the net structure of cellulose microfibrils constituting the pits, the function of the pits is damaged or destroyed, and the pits are opened. (See, e.g., FIG. 1). Hence, drying and treatment solution-permeability of wood are enhanced, which also increases the ability to preserve the wood.

Dissolution of cellulose has traditionally been achieved by dissolving the cellulose using a cellulose-dissolving solvent or hydrolyzing the cellulose into low-molecular-weight compounds and then dissolving them in water. Various types of solvents are conventionally known as cellulose-dissolving solvents, but they contain specific acids, bases, or metal salts and are not human- and environmentally-friendly. Furthermore, known methods for hydrolysis using a strong acid or an enzyme has problems in terms of efficiency as well as other complications.

Among the embodiments provided herein are methods of improving drying and treatment solution permeability of wood by dissolving cellulose microfibrils which form pits, using a cellulose-dissolving solvent for opening them. In particular, the cellulose-dissolving solvent contains an ionic liquid.

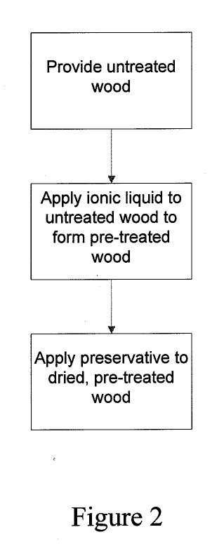

In some embodiments, provided is a method of preserving wood, the method comprising providing untreated wood, applying an ionic liquid to the untreated wood to produce pre-treated wood, where the permeability of the pre-treated wood is higher than the permeability of the untreated wood, and applying a preservative to the pre-treated wood. An illustration of this process is provided in FIG. 2. In the method, untreated wood is provided. Typically, the untreated wood can include hardwood, lumber, or other wood for which a goal is the preservation thereof.

The untreated wood is treated by applying an ionic liquid to the untreated wood. A result of applying an ionic liquid to untreated wood can be to produce pre-treated wood, where the permeability of the pre-treated wood is higher than the permeability of the untreated wood. For example, the permeability of the pre-treated wood to a preservative-containing solution is higher than the permeability of the untreated wood to the same preservative-containing solution. In another example, the permeability of the pre-treated wood to an aqueous solution is higher than the permeability of the untreated wood to the same aqueous solution. The increased permeability of the wood achieved by this method is typically an amount sufficient to facilitate administration of a preservative to the wood and/or an amount sufficient to increase the speed of drying the wood. In some embodiments, the permeability of the pre-treated wood is at least, at least about, more than, or more than about 1.3-fold, 1.5-fold, 1.7-fold, 2-fold, 2.5-fold, 3-fold, or 4-fold relative to the permeability of the untreated wood to the same solution or solvent.

Ionic Liquids

Any of a variety of ionic liquids can be used in the methods provided herein. Typically, the ionic liquids used in the methods provided herein include ionic liquids in which cellulose is soluble. For example, contemplated herein are ionic liquids in which cellulose is sufficiently soluble so as to form a solution of at least, at least about, more than, or more than about 3%, 4%, 5%, 6%, or 7% of cellulose dissolved in the ionic liquid. In some ionic liquids provide herein, the solubility of cellulose is up to, up to about, less than, or less than about 30%, 25% or 20% (w/v) in the ionic liquid. Furthermore, the above listing of lower and upper limits to the solubility of cellulose in the ionic liquid can be combined to create suitable ranges of contemplated solubility of cellulose in the ionic liquid.

Ionic liquids included herein are hydrophilic, and in some embodiments, do no include hydrophobic ionic liquids described in Koch et al. U.S. Pat. No. 5,827,602 or those of Bonhte et al. U.S. Pat. No. 5,683,832. In some embodiments, excluded from the ionic liquids provided herein are ionic liquids that contain one or more fluorine atoms, such as ionic liquids containing BF₄, PF₆, or one or more fluorine atoms covalently bonded to a carbon atom as in a trifluoromethanesulfonate or trifluoroacetate anion. In some embodiments, excluded from the ionic liquids provided herein are ionic liquids that have antimicrobial and mold prevention properties, for example, ionic liquids containing a quaternary ammonium cation having a long chain alkyl group, and other ionic liquids with antimicrobial and mold prevention properties equivalent thereto. Typically, ionic liquids that contain one or more fluorine atoms and ionic liquids that have antimicrobial and mold prevention properties do not possess suitable cellulose-dissolving properties, and, as such, are not suitable for the wood treatment and pre-treatment methods provided herein. Accordingly, in some embodiments provided herein, the methods include applying to wood a preservative that is not an ionic liquid; discussion of applying preservative and preservatives that are not ionic liquids is provided elsewhere herein.

In some embodiments, the ionic liquid is soluble in an aqueous solution. For example, contemplated herein are ionic liquids that are at least 10%, 12%, 15%, 20% or 25% (v/v) soluble in an aqueous solution. In some ionic liquids provided herein, the solubility of the ionic liquid is up to, up to about, less than, or less than about 75%, 80%, or 90% (v/v) in an aqueous solution. Furthermore, the above listing of lower and upper limits to the solubility of ionic liquid in water can be combined to create suitable ranges of contemplated solubility of ionic liquid in water.

While not being limited to the following, it is believed that the ionic liquid dissolves cellulose microfibrils in wood, resulting in improved drying properties and improved ability to apply treatment solutions to the wood. In a tree, water (sap) moves upward through sapwood cells in the trunk and is supplied to the branches and leaves. The pit membrane, which controls water movement, has a valve, a so-called torus. When water is lost, the pit is closed with a lid of the valve by means of the surface tension of water to isolate the cell.

The pit in wooden cellulose structures is composed of a pit border region where a cell wall swells out like a dome shape and is opened at the center, and has a pit membrane having a valve called a torus. The membrane is constituted of the disk-shaped torus and a margo region having a net structure formed by cellulose microfibrils surrounding the torus. Dissolution of cellulose can be achieved by dissolving the cellulose using a cellulose-dissolving solvent. Provided herein is a method of improving drying and treatment solution permeability of wood by dissolving cellulose microfibrils which form pits, using a cellulose-dissolving ionic liquid.

When the ionic liquid is applied to the wood, it is believed that the ionic liquid permeates into the wood. The ionic liquid can then dissolve the cellulose microfibrils. As a result, the function of pits is destroyed, causing the pits to open, which facilitates subsequent drying and application of treatment solution, such as a preservative-containing solution. The ionic liquid does not have a vapor pressure and is nonvolatile, and the ionic liquid can be effective even in small amounts.

Examples of ionic liquids that can be used in the methods provided herein include, but are not limited to ionic liquids that comprise a cation such as:

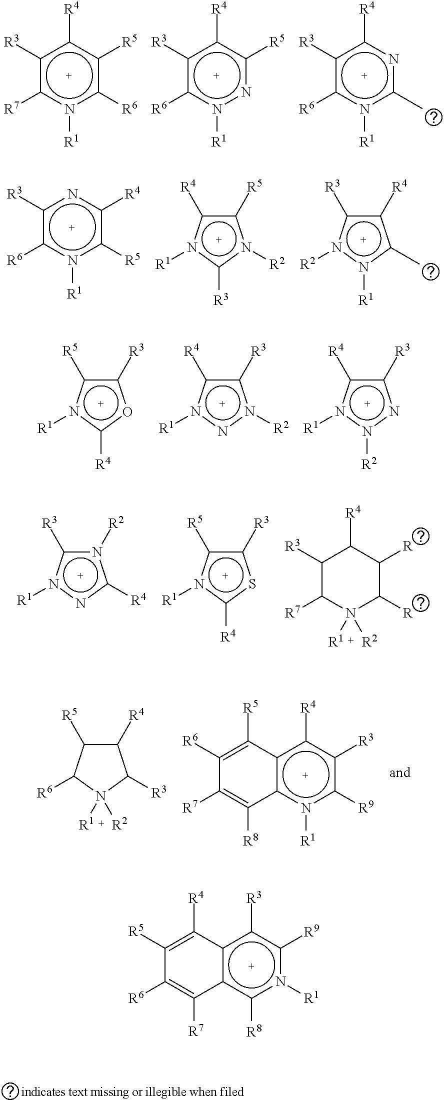

In the above formulas, R¹ is C₁-C₆ alkyl or C₁-C₆ alkoxyalkyl; wherein R² is C₁-C₆ alkyl or C₁-C₆ alkoxyalkyl; and wherein R³, R⁴, R⁵, R⁶, R⁷, R⁸, and R⁹, when present, are each independently hydrogen, hydroxy, C₁-C₆ alkyl, C₁-C₆ alkoxyalkyl, or C₁-C₆ alkoxy. In some embodiments, the ionic liquid contains at least one dialkylimidazolium cation. In some embodiments the ionic liquid contains at least one methylbutylimidazolium cation.

Examples of ionic liquids that can be used in the methods provided herein include, but are not limited to ionic liquids that comprise an anion such as halide, pseudohalide, phosphate and C₁-C₆ carboxylate. In some embodiments, the ionic liquid contains a chloride, acetate, or phosphate anion.

Particular examples of ionic liquids that can be used in the methods provided herein include, but are not limited to dialkylimidazolium chloride, dialkylimidazolium, dialkylimidazolium acetate, dialkylimidazolium phosphate, methylbutylimidazolium chloride, methylbutylimidazolium acetate, methylbutylimidazolium phosphate.

The quantity of ionic liquid applied to the wood is typically determined by the surface area of the wood to be treated. Thus, the quantity of ionic liquid to be applied to the wood can be expressed in terms of unit area of wood. The amount of ionic liquid applied is an amount sufficient to increase the permeability of the wood relative to the permeability of the wood prior to application of the ionic liquid, but typically not in excess of the amount that can be applied to and absorbed into the wood. In some embodiments, the amount of ionic liquid applied to the wood is an amount sufficient to increase the permeability of the wood relative to the permeability of the wood prior to application of the ionic liquid, but an amount not sufficient to preserve the wood absent addition of a further preservative. The amount of ionic liquid can be selected according to the desired level of increased permeability to be achieved. Typically at least, at least about, more than, or more than about 5, 7, 10, 15, 20, 25, 30, 35, 40, 45, or 50 μg/cm² of ionic liquid is applied to the wood. Typically up to, up to about, less than, or less than about 500, 700, 1000, 1500, or 2000 μg/cm² of ionic liquid is applied to the wood. Furthermore, the above listing of lower and upper limits to the amount of ionic liquid applied to the wood can be combined to create suitable ranges of contemplated amounts of ionic liquid applied to the wood.

Mixtures of Ionic Liquids and Water

In some embodiments a mixture of ionic liquid and water is applied to the wood. As provided elsewhere herein, typically the ionic liquid is soluble in aqueous solutions. Accordingly, in some embodiments, an aqueous solution that contains ionic liquid and water is applied to the wood.

In such embodiments, a mixture of an ionic liquid and water, such as an ionic liquid-containing aqueous solution, is applied to wood so as to permeate therein. The water can serve one or more roles: as a diluent to reduce the viscosity, to increase the permeability, and/or to cause efficient infiltration of the ionic liquid. Subsequent to application of the ionic liquid/water mixture, the water can evaporate, whereas ionic liquids are typically non-volatile and do not readily evaporate. Accordingly, as the water evaporates, the ionic liquid can be increasingly concentrated. The concentrated ionic liquid can then serve to dissolve the cellulose microfibrils in accordance with methods provided herein. As a result, the function of pits is damaged or destroyed, causing the pits to open, which facilitates subsequent drying and treatment solution injection.

The amount of ionic liquid and water present in such mixtures can be expressed as the ratio of ionic liquid:water (w/w). The ratio of ionic liquid:water is selected according to the desired effect of the ionic liquid/water mixture. When the amount of ionic liquid is too small, a sufficient amount of ionic liquid does not remain after water is evaporated; and thus, dissolution may not be completed. When the amount of ionic liquid is too large, it may not be cost-efficient at scale. In some embodiments, the ratio of ionic liquid:water is at least, at least about, more than, or more than about 1:200, 1:150, 1:100, 1:90, 1:80, 1:70, 1:60, 1:50, 1:45, 1:40, 1:35, 1:30, 1:25, 1:20, 1:15, or 1:10. In some embodiments, the ratio of ionic liquid:water is up to, up to about, less than, or less than about 1:25, 1:20, 1:15, 1:10, 1:9, 1:8, 1:7, 1:6, or 1:5. Furthermore, the above listing of lower and upper limits to the ratio of ionic liquid:water can be combined to create suitable ranges of ratios of ionic liquid:water. For example, the ionic liquid:water ratio can be 0.1:99.9-10:90, or 0.5:99.5-5:95.

Any of a variety of aqueous solutions can be applied in the methods provided herein. For example, in some embodiments, aqueous solutions that can be applied to wood in accordance with the methods provided herein can contain a small amount of acid. While not intending to be bound to the following, a small amount of acid can have a cellulose-hydrolyzing effect, which may increase the cellulose-dissolving properties of the ionic liquid-containing aqueous solution. In some examples, acids such as sulfuric acid, oxalic acid, sulfurous acid, hydrochloric acid and phosphoric acids can also be added into the ionic liquid-containing aqueous solution. In some embodiments, the quantity of acid added to the aqueous solution can be at least, at least about, more than, or more than about 0.005%, 0.01%, 0.015%, 0.02%, 0.025%, 0.03, 0.04, 0.05, 0.1, 0.2, 0.5% (v/v), or more. In some embodiments, the quantity of acid added to the aqueous solution can be up to, up to about, less than, or less than about 1.0%, 1.5%, 2.0%, 2.5%, 3.0%, 3.5%, 4.5%, or 5.0% (v/v). Furthermore, the above listing of lower and upper limits to the quantity of acid added to the aqueous solution can be combined to create suitable ranges of quantity of acid added to the aqueous solution. Generally, the pH of the solution will be from about pH 1.0 to about pH 4.0, or between about pH 1.0 and about pH 4.0.

In some embodiments, additional materials can be added to the ionic liquid/water mixtures used in the methods provided herein. For example, additional materials can include vegetable oil and mineral oil emulsified and made water-soluble by surfactants such as cationic surfactants octadecyltiimethylammonium chloride, dimethyldioctadecylammonium chloride, chloridebenzalkonium chloride, cetylpyridinium chloride to which are mixed antiseptics, insecticides, ant killer substances, and mold retarders. In some embodiments, known cation-base compounds having a strong sterilization effect can be used, including, but not limited to, DDAC (principal component didecyldimethyl ammonium chloride). It is also known that oil has an effect of preventing cracks or distortions of wood. By using oil and a cation-base compound in combination, it is possible to achieve a preservation effect, and also to prevent cracks or distortions as defects of wood, thereby permitting the treated wood to be more effectively utilized. In addition, the oil component can provide water repellent and preservation effects.

Methods of Applying the Ionic Liquid

The ionic liquid or ionic liquid-containing liquid (collectively referred to as ionic liquid) can be applied to the wood using any of a variety of known methods for applying liquids to wood. Examples of methods include dipping the wood into a liquid, applying the liquid to the wood with a transfer roller, spraying the wood, liquid injection into the wood, slot-die-coating the wood, knife coating the wood, and any other known method for applying liquids to wood. In some embodiments, a method of applying the ionic liquid is performed by a zero-pressure surface-coating method. In some embodiments, a method of applying the ionic liquid is performed by pressure injection at low-pressure. Suitable pressures for the low-pressure liquid injection can be at least, at least about, more than, or more than about, 0.05, 0.1, 0.15, 0.2, 0.25, or 0.3 kg/mm². Typically, the amount applied is up to, up to about, less than, or less than about, 1.0, 1.5, 2.0, 2.5, or 3.0 kg/mm². Furthermore, the above listing of lower and upper limits to pressures for the low-pressure liquid injection can be combined to create suitable ranges of pressures for the low-pressure liquid injection.

Heat Treatment of Wood

In some embodiments, prior to applying ionic liquid to the untreated wood, the untreated wood is subjected to a heat treatment. Typically, the heat treatment is conducted immediately prior to applying the ionic liquid to the untreated wood in order to secure the benefit resultant from the heat treatment. In some embodiments, when wood is heat treated, improvement of efficiency of ionic liquid injection is expected because the pressure in the water-filled pits on the surface of wood is reduced, which results in enhanced permeation of the ionic liquid into the pits.

Any of a variety of known methods can be used in the heat treatment of the wood including, but not limited to dry kiln treatment and wet bulb treatment. As is known in the art, the temperature and duration of the heat treatment can vary depending on the type of heat treatment applied. Typically, the heat treatment is applied in such a manner as to enhance permeation of liquids such as an ionic liquid into the wood, but is not applied so as to substantially diminish the structural integrity of the wood, in accordance with the conventions in the art. For a heat treatment such as kiln treatment, the heat treatment is applied for at least, at least about, more than, or more than about, 30, 40, 50, 60, 70, 80 or 90 minutes at a temperature of at least, at least about, more than, or more than about, 60, 70, 80, 90, 100, 110, 120. In some embodiments, the heat treatment is performed at a temperature that is less than, less than about, no more than, or no more than about 130, 140, 150, 160, 170, 180, 190, 200, or 250° C. The structural integrity of the wood can be assessed by determination of one or more structural properties including, but not limited to compression strength, bending strength, modulus of elasticity in bending, impact bending strength, radial-tangential swelling and shrinkage, and longitudinal swelling and shrinkage, using methods known in the art. In some embodiments of the methods provided herein, one or more of the structural properties of the wood after heat treatment is no less than, no less than about, more than, or more than about, 99, 98, 97, 95, 90, 85, 80, 75, 70, 60, or 50% of the corresponding structural property of the wood prior to the heat treatment.

In methods that include a heat treatment, typically, the heat treatment is performed immediately prior to applying the ionic liquid to the untreated wood. For example, the ionic liquid is applied to the wood after heat treatment at least, at least about, no more than, or no more than about 15, 20, 25, 30, 45 or 60 minutes after the heat treatment.

Drying Wood

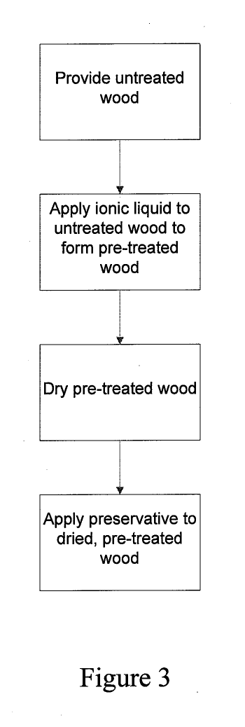

In some embodiments, after applying the ionic liquid to the wood, the resultant pre-treated wood product can be dried. An illustrative embodiment that includes drying wood after applying the ionic liquid is provided in FIG. 3. As contemplated herein, the use of ionic liquids in accordance with the methods provided herein can facilitate and expedite the drying of wood. Accordingly, in some embodiments, a step of drying wood subsequent to applying the ionic liquid to the wood can be performed over shorter times, and/or at lower temperatures, relative to traditional drying methods.

Any of a variety of known methods can be used in the drying the wood including drying in a kiln, or drying under ambient conditions. As is known in the art, the temperature and duration of the heat treatment can vary depending on the drying method applied. Typically, the drying method does not substantially diminish the structural integrity of the wood, in accordance with the conventions in the art. For a drying method such as kiln treatment, the drying is performed for at least, at least about, more than, or more than about, 5, 10, 15, 20, or 30 minutes at a temperature of at least, at least about, more than, or more than about, 40, 45, 50, 60, 70, or 80° C. In some embodiments, the drying is performed at a temperature that is less than, less than about, no more than, or no more than about 90, 100, 110, 120, or 150° C. The structural properties of the wood after drying is typically no less than, no less than about, more than, or more than about, 99, 98, 97, 95, 90, 85, 80, 75, 70, 60, or 50% that of the wood prior to drying.

Methods of Applying the Preservative

In the methods of preserving wood provided herein a preservative is applied to the wood. In some embodiments, the preservative is applied to the wood at the same time as applying the ionic liquid to the wood. In other embodiments, the preservative is applied to the wood subsequent to applying the ionic liquid to the wood.

In embodiments in which the preservative is applied to the wood subsequent to applying the ionic liquid to the wood, the preservative is typically applied within less than, less than about, no more than, no more than about 0.5, 1.0, 2.0, 3.0, 4.0, 5.0, 6.0, 7.0, or 8.0 hours after applying the ionic liquid to the wood. In some embodiments, the preservative is typically applied no less than, no less than about, more than, more than about 0.1, 0.2, 0.3, 0.4, 0.5, 1.0, 2.0, or 3.0 hours after applying the ionic liquid to the wood.

The preservative can be applied to the wood using any of a variety of known methods for applying liquids to wood. Examples of methods include dipping the wood into a liquid, applying the liquid to the wood with a transfer roller, spraying the wood, liquid injection into the wood, slot-die-coating the wood, knife coating the wood, and any other known method for applying liquids to wood. In some embodiments, a method of applying the preservative is performed by a zero-pressure surface-coating method. In some embodiments, a method of applying the preservative is performed by pressure injection at low-pressure. Suitable pressures for the low-pressure liquid injection can be at least, at least about, more than, or more than about, 0.05, 0.1, 0.15, 0.2, 0.25, or 0.3 kg/mm². Typically, the amount applied is up to, up to about, less than, or less than about, 1.0, 1.5, 2.0, 2.5, or 3.0 kg/mm². Furthermore, the above listing of lower and upper limits to pressures for the low-pressure liquid injection can be combined to create suitable ranges of pressures for the low-pressure liquid injection.

Preservatives

Any of a variety of known preservatives can be used in the methods provided herein. Examples of known preservatives include, but are not limited to chromated copper arsenate (CCA), alkaline copper quaternary (ACQ), copper azole, copper HDO (CuHDO), copper chromate, copper citrate, acid copper chromate, ammoniacal copper zinc arsenate (ACZA), boric acid, boric oxides, boric salts, sodium silicate, potassium silicate, bifenthrin, pentachlorophenol, creosote, linseed oil, sunflower oil, rapeseed oil, and other known preservatives.

The quantity of preservative applied to the wood is typically determined by the surface area of the wood to be treated. Thus, the quantity of preservative to be applied to the wood can be expressed in terms of unit area of wood. The amount of preservative applied is an amount sufficient to reduce susceptibility of the wood to decay in accordance with established standards known in the art. In accordance with the methods provided herein, use of ionic liquids can reduce the quantity of preservative required to achieve the same level of preservation as that achieved using traditional methods. Typically, the amount of preservative required to achieve the same level of preservation as that achieved using traditional methods is 30, 35, 40, 45, 50, 60, or 70% less than the amount of preservative used in traditional methods. Typically at least, at least about, more than, or more than about 0.1, 0.5, 1.0, 2.0, 3.0, 4.0 or 5.0 mg/cm² of preservative is applied to the wood. Typically up to, up to about, less than, or less than about 5, 7, 10, 15, 20, 25, 30, 35, 40, 45, or 50 mg/cm² of preservative is applied to the wood. Furthermore, the above listing of lower and upper limits to the amount of preservative applied to the wood can be combined to create suitable ranges of contemplated amounts of preservative applied to the wood.

### Methods of Improving Drying of Wood

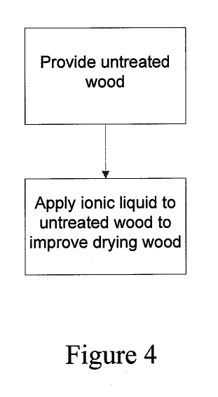

In some embodiments, provided herein are methods of improving drying of wood, where the method includes (a) providing untreated wood; and (b) applying an ionic liquid to the untreated wood to produce treated wood, where the permeability of the treated wood is higher than the permeability of the untreated wood; and where the ionic liquid applied to the untreated wood accelerates drying of the treated wood relative to untreated wood. An illustration of this process is provided in FIG. 4. In the method, untreated wood is provided. As with previous methods described elsewhere herein, typically, the untreated wood can include hardwood, lumber, or other wood for which the goal is the preservation thereof.

The untreated wood is treated by applying to the untreated wood an ionic liquid. A result of applying an ionic liquid to untreated wood can be to produce pre-treated wood, where the permeability of the pre-treated wood is higher than the permeability of the untreated wood. For example, the permeability of the pre-treated wood to a preservative-containing solution is higher than the permeability of the untreated wood to the same preservative-containing solution. In another example, the permeability of the pre-treated wood to an aqueous solution is higher than the permeability of the untreated wood to the same aqueous solution. The increased permeability of the wood achieved by this method is typically an amount sufficient to facilitate administration of a preservative to the wood and/or an amount sufficient to increase the speed of drying the wood. In some embodiments, the permeability of the pre-treated wood is at least, at least about, more than, or more than about 1.3-fold, 1.5-fold, 1.7-fold, 2-fold, 2.5-fold, 3-fold, or 4-fold higher than the permeability of the untreated wood to the same solution or solvent. As contemplated herein, this increased permeability also increases the ability of the wood to release moisture contained therein, which results in improved drying properties of the wood.

In some embodiments, the ionic liquid applied in this method does not preserve the treated wood. As described elsewhere herein, some of the ionic liquids that can be used in the present methods do not have a wood-preserving or antimicrobial effect on the wood. While not wishing to be limited to the following, it is contemplated herein that ionic liquids that are able to provide good drying-improvement properties to the wood do not typically possess wood-preserving or antimicrobial properties. Similarly, ionic liquids that possess suitable levels of wood-preserving or antimicrobial properties do not provide good drying-improvement properties to the wood, and, therefore, are not effective in methods of improving the drying of wood. Accordingly, the type of ionic liquid, quantity of ionic liquid, and/or method for applying the ionic liquid are those selected improve the ability of wood to dry, and are not selected to improve the wood-preserving or antimicrobial properties of the wood. Typically in methods provided herein, the wood-drying ability of the ionic liquid results in a drying time that is at least, at least about, more than, or more than about 90, 85, 80, 75, 70, 60, or 50% the amount of time needed to achieve the same level of dryness as achieved with untreated wood.

The type, quantity and manner for applying ionic liquids in the methods of improving drying of wood correspond to those provided elsewhere herein in regard to methods of preserving and pre-treating wood. Similarly, ionic liquids used in the methods of improving drying of wood can be in aqueous and/or acid solutions corresponding to those provided elsewhere herein in regard to methods of preserving and pre-treating wood. Further, heat treatment can be used in methods of improving drying of wood, as provided elsewhere herein.

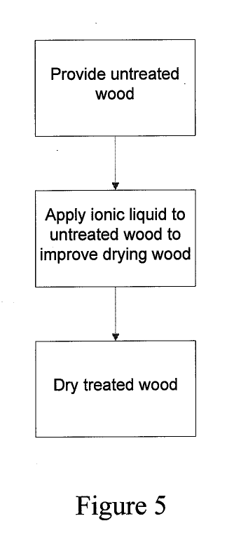

In some embodiments, an additional step of drying the wood can be performed. An illustration of this method is provided in FIG. 5. The details of drying the wood correspond to those provided elsewhere herein in regard to methods of preserving and pre-treating wood.

In some embodiments, the wood produced in the method of improving drying of wood can be subsequently treated with a preservative. The details of treating such wood with a preservative correspond to those provided elsewhere herein in regard to methods of preserving and pre-treating wood.

Wood Products Resultant from the Methods Provided Herein

Further contemplated herein are wood products resultant from any method provided herein. For example, wood products resultant from the methods provided herein include wood products that contain ionic liquids therein. In some embodiments of such wood products, at least, at least about, more than, or more than about 5, 7, 10, 15, 20, 25, 30, 35, 40, 45, or 50 μg/cm² of ionic liquid is present in the wood product. Typically up to, up to about, less than, or less than about 500, 700, 1000, 1500, or 2000 μg/cm² of ionic liquid is present in the wood product.

Also provided herein are preserved wood products, where the preserved wood product contains at least one ionic liquid and at least one preservative that is not an ionic liquid. Typically in such embodiments, the ionic liquid does not act as a preservative, as described elsewhere herein.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### EXAMPLES

Additional embodiments are disclosed in further detail in the following examples, which are not in any way intended to limit the scope of the claims.

### Example 1

### Preservation of Wood Using Pre-Treatment of Wood with Ionic Liquid

An untreated lumber of oak is provided. The untreated wood is subjected to heat treatment by contacting the wood with 2 liters of ionic liquid/acid/water=10/1/89 wt/wt/wt at a temperature of 50° C. for 30 minutes.

An aqueous ionic liquid solution is prepared by combining 500 g of the ionic liquid methylbutylimidazolium chloride with 9500 g of an aqueous solution containing sulfuric acid in water (1.1%). The aqueous ionic liquid solution is applied to the heat-treated wood within 30 minutes after heating, by coating 2 liters of aqueous ionic liquid solution onto the heat-treated wood using a spray gun for 30 minutes at a temperature of 50° C.

After contacting the wood with the ionic liquid solution, the wood is dried for 2 hours at a temperature of 80° C.

A preservative is then applied to the dried wood by contacting the dried wood with 10 g of chromated copper arsenate for 30 minutes at a temperature of 50° C. using a spray gun.

### Examples 2-5

### Preservation of Wood Using Pre-Treatment of Wood with Various Ionic Liquids

Examples 2-5 are performed in the same manner as Example 1, except that the ionic liquid used is methylbutylimidazolium acetate (Example 2), methylbutylimidazolium phosphate (Example 3), butylmethylpyridinium chloride (Example 4), diethylmethylmethoxyethyl ammonium chloride (Example 5).

### Examples 6-9

### Preservation of Various Woods Using Pre-Treatment of Wood with Ionic Liquid

Examples 6-9 are performed in the same manner as Example 1, except that the untreated wood sample used is cherry (Example 6), ebony (Example 7), pine (Example 8), fir (Example 9).

### Examples 10-13

### Preservation of Wood Using Pre-Treatment of Wood with Various Ionic Liquid Solutions

Examples 10-13 are performed in the same manner as Example 1, except that the ionic liquid is provided in an aqueous solution under the following conditions: methylbutylimidazolium chloride/sulfuric acid/water=5/0.1/94.9 wt/wt/wt (Example 10), methylbutylimidazolium chloride/hydrochloric acid/water=5/1/94 wt/wt/wt (Example 11), methylbutylimidazolium phosphate/phosphoric acids/water=10/0.5/89.5 (Example 12), butylmethylpyridinium chloride/sulfuric acid/water=5/0.5/94.5 wt/wt/wt (Example 13).

### Example 14

### Improved Drying of Wood

An untreated lumber of oak is provided. The untreated wood is subjected to heat treatment by contacting the wood with 2 liters of ionic liquid/acid/water=10/1/89 wt/wt/wt at a temperature of 80° C. for 30 minutes.

An aqueous ionic liquid solution is prepared by combining 500 g of the ionic liquid methylbutylimidazolium chloride with 9500 g of an aqueous solution containing sulfuric acid in water (1.1%). The aqueous ionic liquid solution is applied to the heat-treated wood by coating 2 liters of aqueous ionic liquid solution onto the heat-treated wood using a spray gun for 30 minutes at a temperature of 80° C.

After contacting the wood with the ionic liquid solution, the wood is dried for 2 hours at a temperature of 80° C.

The wood treated in the above process, when dried, is expected to have the same degree of dryness as untreated wood when dried for 24 hours at a temperature of 80° C. Accordingly, this process is expected to greatly increase the efficiency of drying the wood.

What is claimed is:

1. A method of preserving wood, the method comprising:
(a) providing untreated wood;
(b) applying an ionic liquid to the untreated wood to produce pre-treated wood, wherein the permeability of the pre-treated wood is higher than the permeability of the untreated wood; and
(c) applying a preservative to the pre-treated wood.

2. The method of claim 1, wherein the ionic liquid comprises as least one cation and at least one anion; and wherein the cation is selected from the group consisting of: 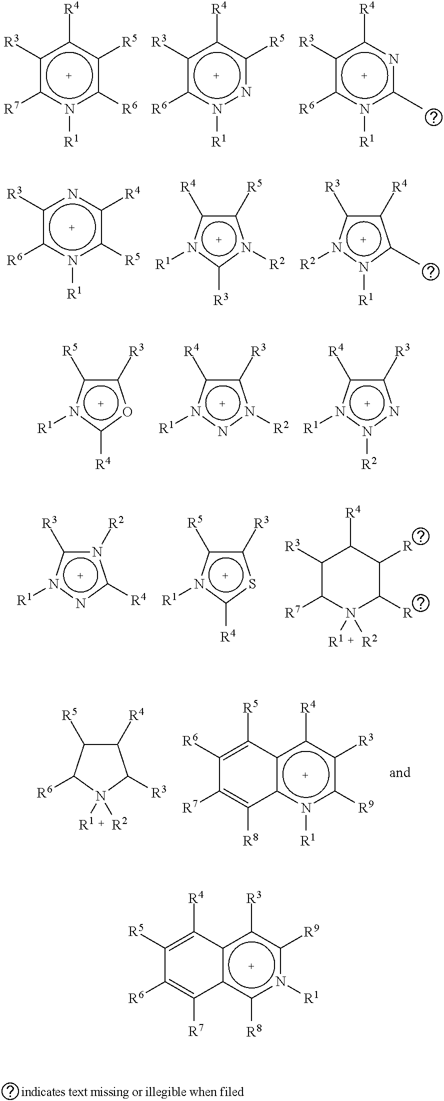
wherein R¹ is C₁-C₆ alkyl or C₁-C₆ alkoxyalkyl; wherein R² is C₁-C₆ alkyl or C₁-C₆ alkoxyalkyl; and wherein R³, R⁴, R⁵, R⁶, R⁷, R⁸, and R⁹, when present, are each independently hydrogen, hydroxy, C₁-C₆ alkyl, C₁-C₆ alkoxyalkyl, or C₁-C₆ alkoxy, and
wherein the anion of the ionic liquid is selected from the group consisting of halide, pseudohalide, phosphate and C₁-C₆ carboxylate.

3. The method of claim 1 or claim 2, wherein the ionic liquid contains at least one dialkylimidazolium cation.

4. The method of any of claims 1-3, wherein the ionic liquid contains at least one methylbutylimidazolium cation.

5. The method of any of claims 1-4, wherein the ionic liquid contains at least one anion selected from the group consisting of chloride, acetate, and phosphate.

6. The method of any of claims 1-5, wherein the ionic liquid is selected from the group consisting of dialkylimidazolium chloride, dialkylimidazolium, dialkylimidazolium acetate, dialkylimidazolium phosphate, methylbutylimidazolium chloride, methylbutylimidazolium acetate, and methylbutylimidazolium phosphate.

7. The method of any of claims 1-6, wherein the ionic liquid is admixed with water prior to applying the ionic liquid to the wood.

8. The method of claim 7, wherein the ratio of ionic liquid:water is about 1:99 to about 1:9 (w/w).

9. The method of any of claims 1-8, wherein the quantity of ionic liquid applied to the wood is about 0.01 mg/cm² to about 1 mg/cm².

10. The method of any of claims 1-9, wherein the ionic liquid is sprayed onto the wood.

11. The method of any of claims 1-10, wherein the ionic liquid is applied to the wood at a pressure of about 0.1 kg/cm² to about 2 kg/cm².

12. The method of any of claims 1-11, wherein the preservative is applied to the pre-treated wood within about 5 hours after applying the ionic liquid to the wood.

13. The method of any of claims 1-12, wherein the preservative is applied to the pre-treated wood no more than about 24 hours after applying the ionic liquid to the wood.

14. The method of any of claims 1-11, wherein the ionic liquid and preservative are simultaneously applied to the wood.

15. A method of improving drying of wood, the method comprising:
(a) providing untreated wood; and
(b) applying an ionic liquid to the untreated wood to produce treated wood, wherein:
the permeability of the treated wood is higher than the permeability of the untreated wood; and
the ionic liquid applied to the untreated wood accelerates drying of the treated wood relative to untreated wood, but does not preserve the treated wood.

16. The method of claim 15, wherein the quantity of ionic liquid applied to the wood is about 0.01 mg/cm² to about 1 mg/cm².

17. The method of claim 15 or claim 16, wherein the ionic liquid is admixed with water prior to contacting wood with the ionic liquid.

18. The method of claim 17, wherein the ratio of ionic liquid:water is about 1:99 to about 1:9 (w/w).

19. The method of any of claims 15-18, further comprising drying the treated wood.

20. A dried wood product that has been dried according to the method of any of claims 15-19.

21. A method of preserving wood comprising applying a preservative to wood, wherein the wood has been treated by the method of any of claims 15-19.

22. A method of preserving wood comprising applying a preservative to wood, wherein, prior to applying the preservative to the wood, the wood contains an ionic liquid.

23. The method of claim 21 or claim 22, wherein the preservative is not an ionic liquid.

24. The method of any of claims 21-23, wherein the preservative is applied to the treated wood within about 5 hours after applying the ionic liquid to the wood.

25. The method of any of claims 21-24, wherein the preservative is applied to the treated wood no more than about 24 hours after applying the ionic liquid to the wood.

26. The method of claim 21, wherein the ionic liquid and preservative are simultaneously applied to the wood.

27. A preserved wood product that has been preserved according to the method of any of claims 1-14 or claims 21-25.
